(19) United States
(12) Patent Application Publication
(10) Pub. No.: US 2024/0351201 A1
(43) Pub. Date: Oct. 24, 2024

(54) ROBOT

(71) Applicant: KAWASAKI JUKOGYO KABUSHIKI KAISHA, Kobe-shi (JP)

(72) Inventors: Tomohisa URAKAMI, Kobe-shi (JP); Nobutaka TSUBOI, Kobe-shi (JP)

(73) Assignee: KAWASAKI JUKOGYO KABUSHIKI KAISHA, Kobe-shi (JP)

(21) Appl. No.: 18/638,817

(22) Filed: Apr. 18, 2024

(30) Foreign Application Priority Data
Apr. 21, 2023 (JP) 2023-070277

(51) Int. Cl. B25J 9/16; B25J 9/06; B25J 13/08

(52) U.S. Cl. CPC B25J 9/1633; B25J 9/06; B25J 9/1607; B25J 9/163; B25J 13/088

(57) ABSTRACT

A robot according to this disclosure includes a robot body including an arm including a plurality of links, a plurality of driving axis units configured to drive the plurality of links, and an inertia sensor(s) included in the arm; and a controller configured to acquire a compensation amount(s) for vibration based on a detection result(s) of the inertia sensor(s) acquired by executing at least one of correction of an inclination(s) of the inertia sensor(s) relative to a to-be-compensated driving axis unit(s), which is/are the driving axis unit(s) that is/are to be subjected to compensation, and elimination of a gravitational acceleration component(s) included in a detection result(s) that is/are detected by the inertia sensor(s).

### CROSS-REFERENCE TO RELATED APPLICATION

The priority application number JP2023-070277, Robot, 21 Apr. 2023, Tomohisa Urakami and Nobutaka Tsuboi, upon which this patent application is based, are hereby incorporated by reference.

### BACKGROUND OF THE INVENTION

### Field of the Invention

The present disclosure relates to a robot.

### Description of the Background Art

Robots are known in the art. Such a robot is disclosed in Japanese Patent Publication No. JP 6155780, for example.

The above Japanese Patent Publication No. JP 6155780 discloses a robot. The robot includes a first arm, a second arm, a third arm, a fourth arm, a fifth arm and a sixth arm. The arms are connected to each other by joints including driving sources. In addition, an angular velocity sensor is arranged in the third arm. In the robot, the angular velocity performs detection so that the driving sources of the joints are controlled based on detection results. Accordingly, vibration of the robot is suppressed.

However, in the robot disclosed in the above Japanese Patent Publication No. JP 6155780, although the angular velocity performs detection so that the driving sources of the joints are controlled based on detection results, because an inclination of the angular velocity sensor relative to the joint that is to be subjected to compensation is not taken into account, it is difficult to accurately compensate for vibration. In addition, because it is difficult to accurately compensate for vibration, it is difficult to accurately suppress the vibration.

### SUMMARY OF THE INVENTION

The present disclosure is intended to solve the above problem, and provides a robot capable of improving accuracy of compensation and accurately suppressing vibration.

A robot according to a first aspect of the present disclosure includes a robot body including an arm including a plurality of links, a plurality of driving axis units configured to drive the plurality of links, and an inertia sensor(s) included in the arm; and a controller configured to acquire a compensation amount(s) for vibration based on a detection result(s) of the inertia sensor(s) acquired by executing at least one of correction of an inclination(s) of the inertia sensor(s) relative to a to-be-compensated driving axis unit(s), which is/are the driving axis unit(s) that is/are to be subjected to compensation, and elimination of a gravitational acceleration component(s) included in a detection result(s) that is/are detected by the inertia sensor(s).

In the robot according to the first aspect of the present disclosure, as discussed above, the controller configured to acquire a compensation amount(s) for vibration based on a detection result(s) of the inertia sensor(s) acquired by executing at least one of correction of an inclination(s) of the inertia sensor(s) relative to a to-be-compensated driving axis unit(s), which is/are the driving axis unit(s) that is/are to be subjected to compensation, and elimination of a gravitational acceleration component(s) included in a detection result(s) that is/are detected by the inertia sensor(s) is provided. Accordingly, in a case in which an inclination of the inertia sensor relative to the to-be-compensated driving axis unit is corrected, because the inclination of the inertia sensor that changes in accordance with a posture of the robot body can be corrected, it is possible to accurately acquire a compensation amount. Also, in a case in which a gravitational acceleration component included in the detection result of the inertia sensor is eliminated, because the gravitational acceleration component, which is inevitably included in the detection result of the inertia sensor, can be eliminated, it is possible to accurately acquire the compensation amount. Consequently, because accuracy of compensation can be improved, it is possible to accurately suppress vibration.

A robot according to a second aspect of the present disclosure includes a robot body including an arm including a plurality of links, a plurality of driving axis units configured to drive the plurality of links, and an inertia sensor(s) included in the arm; and a controller configured to correct a detection result(s) that is/are detected by the inertia sensor(s) to compensate for vibration, and to acquire a compensation amount(s) for the vibration based on the corrected detection result(s) of the inertia sensor(s).

In the robot according to the second aspect of the present disclosure, as discussed above, the controller configured to correct a detection result(s) that is/are detected by the inertia sensor(s) to compensate for vibration, and to acquire a compensation amount(s) for the vibration based on the corrected detection result(s) of the inertia sensor(s) is provided. As a result, a compensation amount can be accurately acquired based on the corrected detection result of the inertia sensor. Consequently, because accuracy of compensation can be improved, it is possible to accurately suppress vibration.

According to the present disclosure, as discussed above, it is possible to improve accuracy of compensation so as to accurately suppress vibration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a robot according to one embodiment.

FIG. 2 is a block diagram showing a control configuration of the robot according to the one embodiment.

FIG. 3 is a diagram illustrating correction of a detection result of an angular velocity sensor according to the one embodiment.

FIG. 4 is a diagram illustrating correction of a detection result of an acceleration sensor according to the one embodiment.

FIG. 5 is a diagram illustrating acquisition of a position compensation amount of a first driving axis unit according to the one embodiment.

FIG. 6 is a diagram illustrating acquisition of a velocity compensation amount of the first driving axis unit according to the one embodiment.

FIG. 7 is a diagram illustrating acquisition of position compensation amounts of second and third driving axis units according to the one embodiment.

FIG. 8 is a diagram illustrating acquisition of a velocity compensation amount of the second driving axis unit according to the one embodiment.

FIG. 9 is a diagram illustrating acquisition of a velocity compensation amount of the third driving axis unit according to the one embodiment.

FIG. 10 is a flowchart illustrating control processing of the acquisition of the position compensation amount in the one embodiment.

FIG. 11 is a flowchart illustrating control processing of the acquisition of the velocity compensation amount in the one embodiment.

### DESCRIPTION OF THE PREFERRED EMBODIMENT

Embodiments embodying the present disclosure will be described with reference to the drawings.

The following description describes a configuration of a robot according to an embodiment with reference to FIGS. 1 to 9.

### (Configuration of Robot)

As shown in FIG. 1, the robot 100 includes a robot body 10, and a controller 20. The robot 100 is an industrial robot, for example. The robot body 10 is a 6-axis vertical multi-joint type. The controller 20 controls operations of the robot body 10.

The robot body 10 includes an arm 11 including a plurality of links 11a, 11b, 11c, 11d, 11e and 11f, a plurality of driving axis units (driving axis) 12a, 12b, 12c, 12d, 12e and 12f configured to drive the plurality of links 11a, 11b, 11c, 11d, 11e and 11f, and an inertia sensor 13 arranged in the arm 11.

The plurality of links 11a, 11b, 11c, 11d, 11e, and 11f are a first link 11a, a second link 11b, a third link 11c, a fourth link 11d, a fifth link 11e and a sixth link 11f. The first link 11a, the second link 11b, the third link 11c, the fourth link 11d, the fifth link 11e, and the sixth link 11f are arranged in this order from a proximal end side. Also, an end effector 30 is attached to a distal end part of the arm 11. The end effector 30 includes a hand configured to grasp a workpiece, an absorber configured to absorb the workpiece, or the like. Also, the arm 11 includes a base 11g arranged in a proximal end part and installed onto a floor, wall, pillar, or the like.

The plurality of driving axis units 12a, 12b, 12c, 12d, 12e, and 12f are a first driving axis unit 12a, a second driving axis unit 12b, a third driving axis unit 12c, a fourth driving axis unit 12d, a fifth driving axis unit 12e and a sixth driving axis unit 12f. The first driving axis unit 12a, the second driving axis unit 12b, the third driving axis unit 12c, the fourth driving axis unit 12d, the fifth driving axis unit 12e, and the sixth driving axis unit 12f are arranged in this order from the proximal end side.

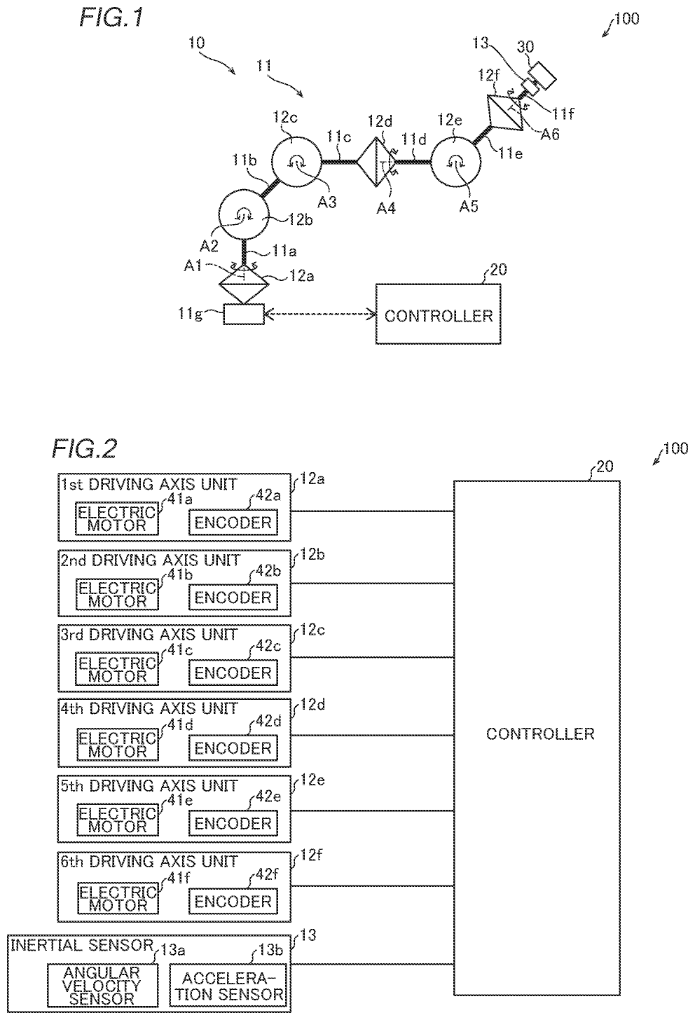

As shown in FIG. 2, the first driving axis unit 12a includes an electric motor 41a and an encoder 42a. Also, the second driving axis unit 12b includes an electric motor 41b and an encoder 41b. Also, the third driving axis unit 12c includes an electric motor 41c and an encoder 41c. Also, the fourth driving axis unit 12d includes an electric motor 41d and an encoder 41d. Also, the fifth driving axis unit 12e includes an electric motor 41e and an encoder 41e. Also, the sixth driving axis unit 12f includes an electric motor 41f and an encoder 41f.

The plurality of driving axis units 12a, 12b, 12c, 12d, 12e and 12f are configured to rotate their corresponding links by driving the electric motors.

As shown in FIG. 1, the first driving axis unit 12a is connected to the base 11. The first driving axis unit 12a is configured to rotate the link 11a with respect to the base 11 about a rotation axis A1. The second driving axis unit 12b is configured to rotate the link 11b with respect to the link 11a about a rotation axis A2 orthogonal to the rotation axis A1.

The third driving axis unit 12c is configured to rotate the link 11c with respect to the link 11b about a rotation axis A3 parallel to the rotation axis A2. The fourth driving axis unit 12d is configured to rotate the link 11d with respect to the link 11c about a rotation axis A4 orthogonal to the rotation axis A3.

The fifth driving axis unit 12e is configured to rotate the link 11e with respect to the link 11d about a rotation axis A5 orthogonal to the rotation axis A4. The sixth driving axis unit 12f is configured to rotate the link 11f with respect to the link 11e about a rotation axis A6 orthogonal to the rotation axis A5.

The inertia sensor 13 is arranged in the distal end part of the arm 11. That is, the inertia sensor 13 is positioned on the distal end side of the arm 11 with respect to the driving axis unit 12a, 12b or 12c to be subjected to compensation, which will be discussed later. The inertia sensor 13 includes an angular velocity sensor 13a and an acceleration sensor 13b, as shown in FIG. 2. The angular velocity sensor 13a is configured to detect an angular velocity at the distal end of the arm 11. The acceleration sensor 13b is configured to detect acceleration at the distal end of the arm 11. The inertia sensor 13 can be a six-axis sensor integrally formed as the angular velocity sensor 13a and the acceleration sensor 13b, or includes a three-axis angular velocity sensor 13a and a three-axis acceleration sensor 13b formed separately from each other.

The controller 20 is configured to control the operations of the robot body 10 by controlling electric power supplied to the electric motors included in the driving axis units of the arm 11. The controller 20 includes a CPU (central processing unit), and a memory. The controller 20 is configured to control the operations of the robot body 10 by executing a predetermined program. Also, the controller 20 is configured to control the robot body 10 so as to so as to suppress the vibration in the robot body by compensating for vibration.

### (Control Relating to Vibration Compensation)

In this embodiment, the controller 20 is configured to correct a detection result of the inertia sensor 13 to compensate for vibration, and to acquire a compensation amount for the vibration based on the corrected detection result of the inertia sensor 13. Specifically, the controller 20 is configured to acquire a compensation amount for vibration based on a detection result of the inertia sensor 13 acquired by executing at least one of correction of an inclination of the inertia sensor 13 relative to a to-be-compensated driving axis unit, which is the driving axis unit that is to be subjected to compensation and elimination of a gravitational acceleration component included in a detection result that is detected by the inertia sensor 13 as correction relating to vibration compensation.

Specifically, the controller 20 is configured to obtain the detection results of the inertia sensor 13 corrected based on inclinations of not-to-be-compensated driving axis units, which are the driving axis unit other than the to-be-compensated driving axis unit, arranged between the inertia sensor 13 and the to-be-compensated driving axis unit. Accordingly, the controller 20 corrects the inclination of the inertia sensor 13 relative to the to-be-compensated driving axis unit. More specifically, the controller 20 is configured to apply coordinate transformation of the not-to-be-compensated driving axis units to the detection result of the inertia sensor 13. Accordingly, the controller 20 corrects the inclination of the inertia sensor 13 relative to the to-be-compensated driving axis unit.

Also, the controller 20 is configured to acquire the gravitational acceleration component based on a rotation matrix based on coordinate transformation matrices of the plurality of driving axis units 12a, 12b, 12c, 12d, 12e and 12f, and to subtract the acquired gravitational acceleration component from the detection result of the inertia sensor 13. Accordingly, the controller 20 eliminates the gravitational acceleration component included in the detection result of the inertia sensor 13.

In this embodiment, the controller 20 is configured to acquire position compensation amounts based on the detection results of the angular velocity sensor 13a, and to acquire velocity compensation amounts based on detection results of the acceleration sensor 13b.

Specifically, the controller 20 is configured to acquire the position compensation amounts based on the detection results of the angular velocity sensor 13a that are obtained by executing correction of inclinations of the angular velocity sensor 13a relative to to-be-compensated driving axis units and correction of angular velocity components of the not-to-be-compensated driving axis units arranged between the angular velocity sensor 13a and the to-be-compensated driving axis unit, and angular velocity instructions to the to-be-compensated driving axis units.

Also, the controller 20 is configured to acquire the velocity compensation amount based on the detection results of the acceleration sensor 13b that are obtained by executing correction of inclinations of the acceleration sensor 13b relative to the to-be-compensated driving axis units and elimination of a gravitational acceleration component included in the detection result of the acceleration sensor 13b, and acceleration instructions to the to-be-compensated driving axis units.

In this embodiment, the controller 20 is configured to acquire compensation amounts of the three driving axis units, which are the first driving axis unit 12a, the second driving axis unit 12b and the third driving axis unit 12c. The to-be-compensated driving axis unit refers to the first driving axis unit 12a, the second driving axis unit 12b or the third driving axis unit 12c. The not-to-be-compensated driving axis units arranged between the inertia sensor 13 and the to-be-compensated driving axis unit refer to the second driving axis unit 12b, the third driving axis unit 12c, the fourth driving axis unit 12d, the fifth driving axis unit 12e and the sixth driving axis unit 12f in a case in which the to-be-compensated driving axis unit is the first driving axis unit 12a. Also, the not-to-be-compensated driving axis units arranged between the inertia sensor 13 and the to-be-compensated driving axis unit refer to the fourth driving axis unit 12d, the fifth driving axis unit 12e and the sixth driving axis unit 12f in a case in which the to-be-compensated driving axis unit is the second driving axis unit 12b or the third driving axis unit 12c. The following description describes acquisition of the compensation amount by the controller 20 in detail.

### <Theory of Compensation Amount Acquisition>

Theory of acquisition of a compensation amount is now described.

An equation of motion for vibration is represented by the following formula (1)

$$\begin{matrix}[ Equation 1 ] & \\ M \ddot{W} + k ( - Z + W ) = 0 , & ( 1 )\end{matrix}$$

where M is a mass of the arm, W is a deviation amount of between a position of an instruction and an actual position due to vibration, Z is a compensation amount, and K is a spring constant.

If the deviation amount W is not zero, the deviation amount W is brought into convergence to zero. Here, in a case in which the compensation amount Z is represented by the following formula (2) where F is a coefficient, the term of the second derivative of the deviation amount W is represented by the following formula (3).

$$\begin{matrix}[ Equation 2 ] & \\ Z = - F \frac{M}{k} \dot{W} & ( 2 )\end{matrix}$$

$$\ddot{W} = - F \dot{W} - \frac{k}{M} W \qquad ( 3 )$$

In the term of the second derivative of the deviation amount W of formula (3), a coefficient of the first derivative term is −F. For this reason, the deviation amount W converges with a time constant of 1/F. Accordingly, the position compensation amount is represented by the following formula (4). Also, the velocity compensation amount is represented by the following formula (5)

$$\begin{matrix}[ Equation 3 ] & \\ {Z}_{p} = - F \frac{M}{k} \dot{W} , & ( 4 )\end{matrix}$$

$${Z}_{v} = - F \frac{M}{k} \ddot{W} , \qquad ( 5 )$$

where Zp is the position compensation amount, and Zv is the velocity compensation amount.

The first derivative term of the deviation amount W is represented by the following formula (6) by using an actual velocity of the arm 11 and the velocity instruction. The second derivative term of the deviation amount W is represented by the following formula (7) by using the actual acceleration of the arm 11 and an acceleration instruction.

$$\begin{matrix}[ Equation 4 ] & \\ \dot{W} = {V}_{FB} - {V}_{FF} & ( 6 )\end{matrix}$$

$$\ddot{W} = {A}_{FB} - {A}_{FF} \qquad ( 7 )$$

In the above formulas, VFB is the actual velocity of the arm 11, VFF is the velocity instruction, AFB is the actual acceleration of the arm 11, and AFF is the acceleration instruction.

Accordingly, the position and velocity compensation amounts are represented by the following formulas (8) and (9), respectively.

$$\begin{matrix}[ Equation 5 ] & \\ {Z}_{p} = - F \frac{M}{k} ( {V}_{FB} - {V}_{FF} ) & ( 8 )\end{matrix}$$

$${Z}_{v} = - F \frac{M}{k} ( {A}_{FB} - {A}_{FF} ) \qquad ( 9 )$$

The detection result of the angular velocity sensor 13a that is obtained by executing correction of an inclination of the angular velocity sensor 13a relative to the to-be-compensated driving axis unit and correction of an angular velocity component of the not-to-be-compensated driving axis unit arranged between the angular velocity sensor 13a and the to-be-compensated driving axis unit is used as the actual velocity of the arm 11. Also, the detection result of the acceleration sensor 13b that is obtained by executing correction of an inclination of the acceleration sensor 13b relative to the to-be-compensated driving axis unit and elimination of a gravitational acceleration component included in the detection result of the acceleration sensor 13b is used as the actual acceleration of the arm 11.

### <Correction of Detection Result of Angular Velocity Sensor>

The correction of the detection result of the angular velocity sensor 13a is described.

Because the inclination of the angular velocity sensor 13a relative to the to-be-compensated driving axis unit changes in accordance with a posture of the robot body 10, the inclination of the angular velocity sensor 13a relative to the to-be-compensated driving axis unit is to be corrected. Specifically, in a case in which the to-be-compensated driving axis unit is the first driving axis unit 12a, the detection result of the angular velocity sensor 13a that is obtained by executing correction of the inclination of the angular velocity sensor 13a relative to the to-be-compensated driving axis unit is represented by the following formula (10). Also, in a case in which the to-be-compensated driving axis unit is the second driving axis unit 12b or the third driving axis unit 12c, the detection result of the angular velocity sensor 13a that is obtained by executing correction of the inclination of the angular velocity sensor 13a relative to the to-be-compensated driving axis unit is represented by the following formula (11). Because the rotation axes of the second driving axis unit 12b and the third driving axis unit 12c are parallel to each other, and operating directions of the second driving axis unit 12b and the third driving axis unit 12c are the same, it is not necessary to correct the inclination of the third driving axis unit 12c in the second driving axis unit 12b.

$$\begin{matrix}[ Equation 6 ] & \\ {V}_{fix} = T\_L1 \_J2 * T\_J2 \_L2 * T\_L2 \_J3 * T\_J3 \_L3 * T\_L3 \_J4 * T\_J4 \_L4 * T\_L4 \_J5 * T\_J5 \_L5 * T\_L5 \_J6 * T\_J6 \_L6 * {V}_{sensor} & ( 10 )\end{matrix}$$

$${V}_{fix} = T\_L3 \_J4 * T\_J4 \_L4 * T\_L4 \text{} \_J5 * T\_J5 \_L5 * T\_L5 \_J6 * T\_J6 \_L6 * {V}_{sensor} \qquad ( 11 )$$

In the above formulas, Vsensor is the detection result of the angular velocity sensor 13a, Vfix is the detection result of the angular velocity sensor 13a after correction, T_LX_JY is a coordinate transformation matrix from a X-the link to a Y-th driving axis unit, and T_JX_LY is a coordinate transformation matrix from a X-th driving axis unit to a Y-th link.

In formula (10), the inclination of the angular velocity sensor 13a relative to the to-be-compensated driving axis unit 12a is corrected by correcting the detection result of the angular velocity sensor 13a based on the inclinations of the not-to-be-compensated driving axis units 12b, 12c, 12d, 12e and 12f arranged between the angular velocity sensor 13a and the to-be-compensated driving axis unit 12a. Also, in formula (11), the inclination of the angular velocity sensor 13a relative to the to-be-compensated driving axis unit 12b or 12c is corrected by correcting the detection result of the angular velocity sensor 13a based on the inclinations of the not-to-be-compensated driving axis units 12d, 12e and 12f arranged between the angular velocity sensor 13a and the to-be-compensated driving axis unit 12b or 12c. In both formulas (10) and (11), the inclination of the angular velocity sensor 13a relative to the to-be-compensated driving axis unit is corrected by applying coordinate transformations of the not-to-be-compensated driving axis units to the detection result of the angular velocity sensor 13a.

Because the detection result of the angular velocity sensor 13a includes the angular velocity components of the not-to-be-compensated driving axis units, the angular velocity components of the not-to-be-compensated driving axis unit are to be corrected based on the detection result of the angular velocity sensor 13a. Specifically, the angular velocity components of the not-to-be-compensated driving axis units are acquired based on information from the encoders of the not-to-be-compensated driving axis units. Subsequently, the detection result of the angular velocity sensor 13a is corrected based on the angular velocity components of the not-to-be-compensated driving axis units by subtracting the angular velocity components of the not-to-be-compensated driving axis units from the detection result of the angular velocity sensor 13a.

In a case in which the to-be-compensated driving axis unit is the first driving axis unit 12a, the detection result of the angular velocity sensor 13a is corrected based on the angular velocity components of the not-to-be-compensated driving axis units 12b, 12c, 12d, 12e and 12f by subtracting the angular velocity components of the not-to-be-compensated driving axis units 12b, 12c, 12d, 12e and 12f from the detection result of the angular velocity sensor 13a. Also, in a case in which the to-be-compensated driving axis unit is the second driving axis unit 12b or the third driving axis unit 12c, the detection result of the angular velocity sensor 13a is corrected based on the angular velocity components of the not-to-be-compensated driving axis units 12d, 12e and 12f by subtracting the angular velocity components of the not-to-be-compensated driving axis units 12d, 12e and 12f from the detection result of the angular velocity sensor 13a. In the case in which the to-be-compensated driving axis unit is the first driving axis unit 12a, because the angular velocity components of the second driving axis unit 12b and the third driving axis unit 12c do not affect the detection result of the angular velocity sensor, subtraction of the angular velocity components of the second driving axis unit and the third driving axis unit do not necessarily to be executed.

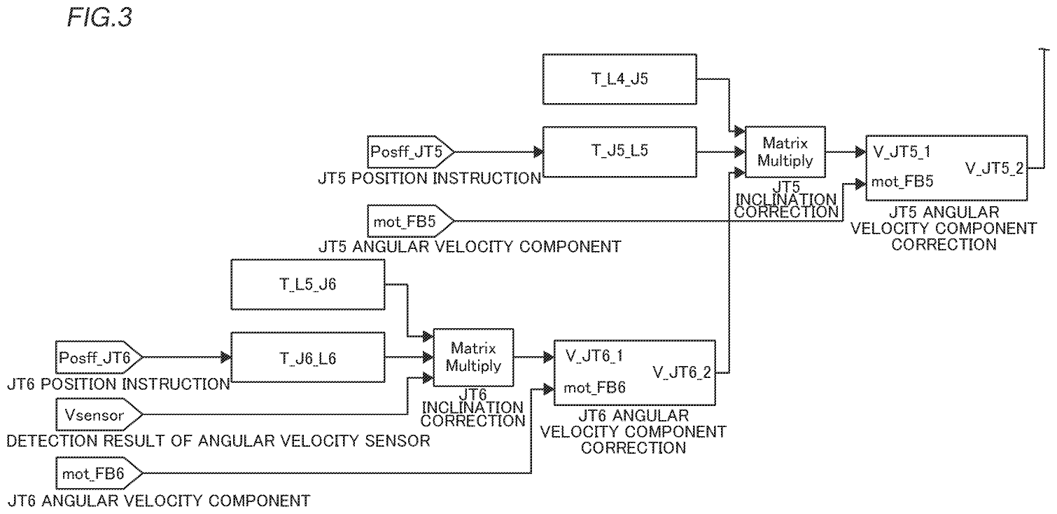

FIG. 3 is a diagram illustrating correction of the detection result of the angular velocity sensor 13a. A coordinate transformation matrix T_L5_J6 is acquired as shown in FIG. 3. Also, a coordinate transformation matrix T_J6_L6 is acquired based on a position instruction Posff_JT6 to the sixth driving axis unit 12f. Also, the detection result Vsensor is acquired from the angular velocity sensor 13a. Subsequently, a detection result V_JT6_1 after correction of an inclination of the sixth driving axis unit 12f is acquired by multiplying the detection result Vsensor by the coordinate transformation matrix T_J6_L6 and the coordinate transformation matrix T_L5_J6.

Also, an angular velocity component mot_FB6 of the sixth driving axis unit 12f is acquired based on information from the encoder 42f of the sixth driving axis unit 12f. Subsequently, a detection result V_JT6_2 after correction of the inclination of the sixth driving axis unit 12f and correction of the angular velocity component of the sixth driving axis unit 12f is acquired by subtracting the angular velocity component mot_FB6 of the sixth driving axis unit 12f from the detection result V_JT6_1.

Subsequently, a coordinate transformation matrix T_L4_J5 is acquired. Also, a coordinate transformation matrix T_J5_L5 is acquired based on a position instruction Posff_JT5 to the fifth driving axis unit 12e. Subsequently, a detection result V_JT5_1 after correction of the inclination of the sixth driving axis unit 12f, correction of the angular velocity component of the sixth driving axis unit 12f and correction of an inclination of the fifth driving axis unit 12e is acquired by multiplying the detection result V_JT6_2 by the coordinate transformation matrix T_J5_L5 and the coordinate transformation matrix T_L4_J5.

Also, an angular velocity component mot_FB5 of the fifth driving axis unit 12e is acquired based on information from the encoder 42e of the fifth driving axis unit 12e. Subsequently, a detection result V_JT5_2 after correction of the inclination of the sixth driving axis unit 12f, correction of the angular velocity component of the sixth driving axis unit 12f, correction of the inclination of the fifth driving axis unit 12e and an angular velocity component of the fifth driving axis unit 12e is acquired by subtracting the angular velocity component mot_FB5 of the fifth driving axis unit 12e from the detection result V_JT5_1. Although only the correction of the fifth driving axis unit 12e and the sixth driving axis unit 12f is shown for ease of the illustration in FIG. 3, correction of driving axis units from the sixth and fifth driving axis units to the fourth driving axis unit 12d, the third driving axis unit 12c and the second driving axis unit 12b is similarly executed in the case in which the to-be-compensated driving axis unit is the first driving axis unit 12a. Also, in the case in which the to-be-compensated driving axis unit is the second driving axis unit 12b or the third driving axis unit 12c, correction of driving axis units from the sixth and fifth driving axis units to the fourth driving axis unit 12d is similarly executed. A value that is finally acquired is acquired as Vfix, which is used to acquire the position compensation amount.

### <Correction of Detection Result of Acceleration Sensor>

The correction of the detection result of the acceleration sensor 13b is described.

Because the detection result of acceleration sensor 13b inevitably includes the gravitational acceleration component, the gravitational acceleration component included in the detection result of the acceleration sensor 13b is eliminated. Specifically, based on the coordinate transformation matrices of plurality of driving axis units 12a, 12b, 12c, 12d, 12e, and 12f, the rotation matrix is represented by the following formula (12). Also, the gravitational acceleration component is represented by the following formula (13). The detection result of the acceleration sensor 13b that is obtained by executing elimination of the gravitational acceleration component included in the detection result of the acceleration sensor 13b is represented by the following equation (14)

$$\begin{matrix}[ Equation 7 ] & \\ R = T\_L0 \_J1 * T\_J1 \_L1 * T\_L1 \text{} \_J2 * T\_J2 \_L2 * T\_L2 \_J3 * T\_J3 \_L3 * T\_L3 \_J4 * T\_J4 \text{} \_L4 * T\_L4 \_J5 * T\_J5 \_L5 * T\_L5 \_J6 * T\_J6 \_L6 , & ( 12 )\end{matrix}$$

$$G = {R [ 00 - g ]}^{T} \qquad ( 13 )$$

$${A}_{grav} = {A}_{sensor} - G \qquad ( 14 )$$

In the above formulas, R is the rotation matrix, G is the gravitational acceleration component, g is a gravitational acceleration, Asensor is the detection result of the acceleration sensor 13b, Agrav is the detection result of the acceleration sensor 13b after elimination of the gravitational acceleration component, and T_L0_J1 is a coordinate transformation matrix from the base 11g to the first driving axis unit 12a.

In formulas (12) and (13), the gravitational acceleration component is acquired based on the rotation matrix based on the coordinate transformation matrices of the plurality of driving axis units 12a, 12b, 12c, 12d, 12e, and 12f. In formula (14), the gravitational acceleration component included in the detection result of the inertia sensor 13 is eliminated by subtracting the gravitational acceleration component from the detection result of the inertia sensor 13.

Also, because the inclination of the acceleration sensor 13b relative to the to-be-compensated driving axis unit changes in accordance with a posture of the robot body 10, the inclination of the acceleration sensor 13b relative to the to-be-compensated driving axis unit is to be corrected. In a case in which the to-be-compensated driving axis unit is the first driving axis unit 12a, the detection result of the acceleration sensor 13b that is obtained by executing correction of the inclination of the acceleration sensor 13b with respect to the to-be-compensated driving axis unit is represented by the following formula (15). Also, in a case in which the to-be-compensated driving axis unit is the second driving axis unit 12b or the third driving axis unit 12c, the detection result of the acceleration sensor 13b that is obtained by executing correction of the inclination of the acceleration sensor 13b with respect to the to-be-compensated driving axis unit is represented by the following formula (16). Because the rotation axes of the second driving axis unit 12b and the third driving axis unit 12c are parallel to each other, and operating directions of the second driving axis unit 12b and the third driving axis unit 12c are the same, it is not necessary to correct the inclination of the third driving axis unit 12c in the second driving axis unit 12b.

$$\begin{matrix}[ Equation 8 ] & \\ {A}_{fix} = T\_L1 \_J2 * T\_J2 \_L2 * T\_L2 \_J3 * T\_J3 \_L3 * T\_L3 \_J4 * T\_J4 \_L4 * T\_L4 \_J5 * T\_J5 \_L5 * T\_L5 \_J6 * T\_J6 \_L6 * {A}_{grav} & ( 15 )\end{matrix}$$

$${A}_{fix} = T\_L3 \_J4 * T\_J4 \_L4 * T\_L4 \_J5 * T\_J5 \_L5 * T\_L5 \_J6 * T\_J6 \_L6 * {A}_{grav} \qquad ( 16 )$$

In the above formulas, Agrav is the detection result of the acceleration sensor 13b after elimination of the gravitational acceleration component, and Afix is a detection result of the acceleration sensor 13b after correction.

In formula (15), the inclination of the acceleration sensor 13b relative to the to-be-compensated driving axis unit 12a is corrected by correcting the detection result of the acceleration sensor 13b based on the inclinations of the not-to-be-compensated driving axis units 12b, 12c, 12d, 12e and 12f arranged between the acceleration sensor 13b and the to-be-compensated driving axis unit 12a. Also, in formula (16), the inclination of the acceleration sensor 13b relative to the to-be-compensated driving axis unit 12b or 12c is corrected by correcting the detection result of the acceleration sensor 13b based on the inclinations of the not-to-be-compensated driving axis units 12d, 12e and 12f arranged between the acceleration sensor 13b and the to-be-compensated driving axis unit 12b or 12c. In both formulas (15) and (16), the inclination of the acceleration sensor 13b relative to the to-be-compensated driving axis unit is corrected by applying coordinate transformations of the not-to-be-compensated driving axis units to the detection result of the acceleration sensor 13b.

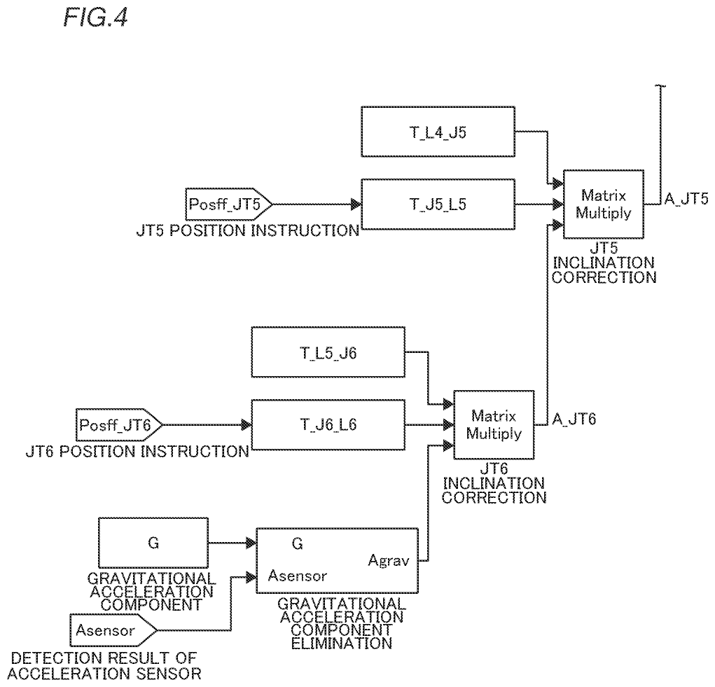

FIG. 4 is a diagram illustrating correction of the detection result of the acceleration sensor 13b. As shown in FIG. 4, the gravitational acceleration component G based on the rotation matrix R is acquired. Also, the detection result Asensor acquired from the acceleration sensor 13b. Subsequently, a detection result Agrav obtained by executing elimination of the gravitational acceleration component G is acquired by subtracting the gravitational acceleration component G from the detection result Asensor.

Also, the coordinate transformation matrix T_L5_J6 is acquired. Also, a coordinate transformation matrix T_J6_L6 is acquired based on a position instruction Posff_JT6 to the sixth driving axis unit 12f. Subsequently, a detection result A_JT6 after elimination of the gravitational acceleration component G and correction of an inclination of the sixth driving axis unit 12f is acquired by multiplying the detection result Agrav by the coordinate transformation matrix T_J6_L6 and the coordinate transformation matrix T_L5_J6.

Subsequently, a coordinate transformation matrix T_L4_J5 is acquired. Also, a coordinate transformation matrix T_J5_L5 is acquired based on a position instruction Posff_JT5 to the fifth driving axis unit 12e. Subsequently, a detection result V_JT5 after elimination of the gravitational acceleration component G, correction of an inclination of the sixth driving axis unit 12f, and correction of an inclination of the fifth driving axis unit 12e is acquired by multiplying the detection result A_JT6 by the coordinate transformation matrix T_J5_L5 and the coordinate transformation matrix T_L4_J5.

Although only the correction of the fifth driving axis unit 12e and the sixth driving axis unit 12f is shown for ease of the illustration in FIG. 4, correction of driving axis units from the sixth and fifth driving axis units to the fourth driving axis unit 12d, the third driving axis unit 12c and the second driving axis unit 12b is similarly executed in the case in which the to-be-compensated driving axis unit is the first driving axis unit 12a. Also, in the case in which the to-be-compensated driving axis unit is the second driving axis unit 12b or the third driving axis unit 12c, correction of driving axis units from the sixth and fifth driving axis units to the fourth driving axis unit 12d is similarly executed. A value that is finally acquired is acquired as Afix, which is used to acquire the velocity compensation amount.

### <Acquisition of Position Compensation for First Driving Shaft>

Acquisition of the position compensation amount for the first driving axis unit 12a is described.

FIG. 5 is a diagram illustrating exemplary acquisition of a position compensation amount of the first driving axis unit 12a based on the above formula (8). As shown in FIG. 5, the detection result Vfix_JT1 of the angular velocity sensor 13a that is obtained by executing correction of an inclination of the angular velocity sensor 13a relative to the to-be-compensated driving axis unit 12a and correction of an angular velocity component of the not-to-be-compensated driving axis unit 12b, 12c, 12d, 12e and 12f arranged between the angular velocity sensor 13a and the to-be-compensated driving axis unit 12a is acquired. Also, an angular velocity instruction VFF_JT1 to the first driving axis unit 12a is acquired. Subsequently, (VFF_JT1−Vfix_JT1) is acquired by subtracting the detection result Vfix_JT1 from the angular velocity instruction VFF_JT1. Also, inertia H00 about the first driving axis unit 12a is acquired. Also, a spring constant Ks1 of the arm 11 is acquired. Subsequently, a position compensation amount Zp_JT1 for the first driving axis unit 12a is acquired by multiplying (VFF_JT1−Vfix_JT1) by inertia H00 and then dividing by the spring constant Ks1. The position compensation amount Zp_JT1 is multiplied by a predetermined gain, and then converted into a current instruction, which is fed back to the current instruction to the electric motor 41a. When the position compensation amount Zp_JT1 is fed back to the current instruction to the electric motor 41a, a low frequency component such as noise and offset is eliminated from the position compensation amount Zp_JT1 by a high pass filter.

### <Acquisition of Velocity Compensation for First Driving Shaft>

Acquisition of the velocity compensation amount for the first driving axis unit 12a is described.

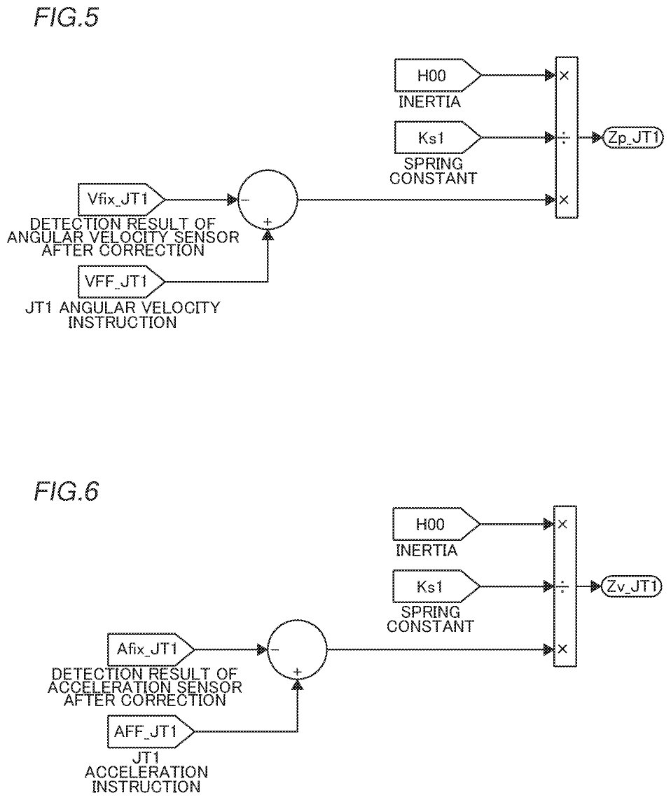

FIG. 6 is a diagram illustrating exemplary acquisition of a velocity compensation amount of the first driving axis unit 12a based on the above formula (9). As shown in FIG. 6, the detection result Afix_JT1 of the acceleration sensor 13b that is obtained by executing correction of an inclination of the acceleration sensor 13b relative to the to-be-compensated driving axis unit 12a and elimination of a gravitational acceleration component included in the detection result of the acceleration sensor 13b is acquired. Also, an acceleration instruction AFF_JT1 to the first driving axis unit 12a is acquired. Specifically, similar to correction of the inclination of the acceleration sensor 13b, the acceleration instruction AFF_JT1 to the first driving axis unit 12a is acquired by applying coordinate transformation of the not-to-be-compensated driving axis units 12b, 12c, 12d, 12e and 12f, which are driving axis units other than the to-be-compensated driving axis unit 12a, to the acceleration instruction to the distal end of the arm 11.

Subsequently, (AFF_JT1−Afix_JT1) is acquired by subtracting the detection result Afix_JT1 from the angular velocity instruction AFF_JT1. Also, inertia H00 about the first driving axis unit 12a is acquired. Also, the spring constant Ks1 of the arm 11 is acquired. Subsequently, a velocity compensation amount Zv_JT1 for the first driving axis unit 12a is acquired by multiplying (AFF_JT1−Afix_JT1) by inertia H00 and then dividing by the spring constant Ks1. The velocity compensation amount Zv_JT1 is multiplied by a predetermined gain, and then converted into a current instruction, which is fed back to the current instruction to the electric motor 41a. When the velocity compensation amount Zv_JT1 is fed back to the current instruction to the electric motor 41a, a low frequency component such as noise and offset is eliminated from the velocity compensation amount Zv_JT1 by a high pass filter.

### <Acquisition of Position Compensation for Second and Third Driving Shafts>

Acquisition of the position compensation amount for the second driving axis unit 12b and the third driving axis unit 12c is described. Because the rotation axes of the second driving axis unit 12b and the third driving axis unit 12c are parallel to each other, and operating directions of the second driving axis unit 12b and the third driving axis unit 12c are the same, the position compensation for the second driving axis unit 12b and the third driving axis unit 12c is acquired based on interference of inertia of the second driving axis unit 12b and the third driving axis unit 12d.

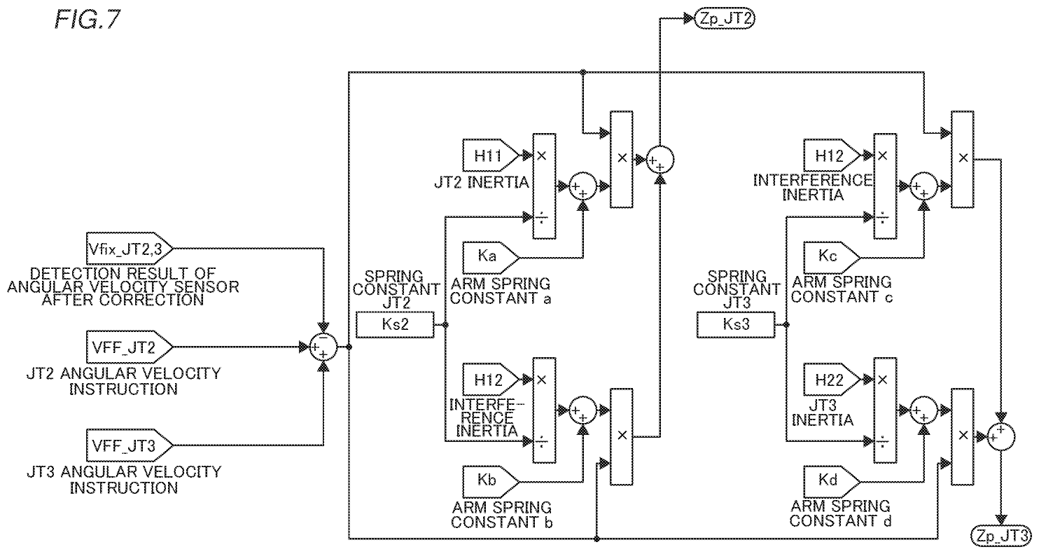

FIG. 7 is a diagram illustrating exemplary acquisition of position compensation amounts of the second driving axis unit 12b and the third driving axis unit 12c based on the above equation (8). As shown in FIG. 7, the detection result Vfix_JT2,3 of the angular velocity sensor 13a that is obtained by executing correction of an inclination of the angular velocity sensor 13a relative to the to-be-compensated driving axis unit 12b or 12c and correction of an angular velocity component of the not-to-be-compensated driving axis unit 12d, 12e and 12f arranged between the angular velocity sensor 13a and the to-be-compensated driving axis unit 12b or 12c is acquired. Also, the angular velocity instruction VFF_JT2 to the second driving axis unit 12b is acquired. Also, the angular velocity instruction VFF_JT3 of the third driving axis unit 12c is acquired. Subsequently, (VFF_JT2+VFF_JT3−Vfix_JT2,3) is acquired by adding the angular velocity instruction VFF_JT2 and the angular velocity instruction VFF_JT2 together, and by subtracting the detection result Vfix_JT2,3.

Also, inertia H11 about the second driving axis unit 12b is acquired. Also, a spring constant Ks2 of the second driving axis unit 12b is acquired. Subsequently, H11/Ks2 is acquired by dividing the inertia H11 by the spring constant Ks2. (H11/Ks2+Ka) is acquired by adding H11/Ks2 and the arm spring constant Ka together. Subsequently, (H11/Ks2+Ka)×(VFF_JT2+VFF_JT3−Vfix_JT2,3) is acquired by multiplying (H11/Ks2+Ka) by (VFF_JT2+VFF_JT3−Vfix_JT2,3).

Also, the interference inertia H12 between the second driving axis unit 12b and the third driving axis unit 12c is acquired. Also, the spring constant Ks2 of the second driving axis unit 12b is acquired. Subsequently, H12/Ks2 is acquired by dividing the interference inertia H12 by the spring constant Ks2. (H12/Ks2+Kb) is acquired by adding H12/Ks2 and the arm spring constant Kb together. Subsequently, (H12/Ks2+Kb)×(VFF_JT2+VFF_JT3−Vfix_JT2,3) is acquired by multiplying (H12/Ks2+Kb) by (VFF_JT2+VFF_JT3−Vfix_JT2,3).

Subsequently, the position compensation Zp_JT2 for the second driving axis unit 12b is acquired by adding (H11/Ks2+Ka)×(VFF_JT2+VFF_JT3−Vfix_JT2,3) and (H12/Ks2+Kb)×(VFF_JT2+VFF_JT3−Vfix_JT2,3) together.

Also, inertia H22 about the third driving axis unit 12c is acquired. Also, a spring constant Ks3 of the third driving axis unit 12c is acquired. Subsequently, H22/Ks3 is acquired by dividing the inertia H22 by the spring constant Ks3. (H22/Ks3+Kd) is acquired by adding H22/Ks3 and the arm spring constant Kd together. Subsequently, (H22/Ks3+Kd)×(VFF_JT2+VFF_JT3−Vfix_JT2,3) is acquired by multiplying (H22/Ks3+Kd) by (VFF_JT2+VFF_JT3−Vfix_JT2,3).

Also, the interference inertia H12 between the second driving axis unit 12b and the third driving axis unit 12c is acquired. Also, a spring constant Ks3 of the third driving axis unit 12b is acquired. Subsequently, H12/Ks3 is acquired by dividing the interference inertia H12 by the spring constant Ks3. (H12/Ks3+Kc) is acquired by adding H12/Ks3 and the arm spring constant Kc together. Subsequently, (H12/Ks3+Kc)×(VFF_JT2+VFF_JT3−Vfix_JT2,3) is acquired by multiplying (H12/Ks3+Kc) by (VFF_JT2+VFF_JT3−Vfix_JT2,3).

Subsequently, the position compensation Zp_JT3 for the third driving axis unit 12c is acquired by adding (H22/Ks3+Kd)×(VFF_JT2+VFF_JT3−Vfix_JT2,3) and (H12/Ks3+Kc)×(VFF_JT2+VFF_JT3−Vfix_JT2,3) together.

The position compensation amount Zp_JT2 and the position compensation amount Zp_JT3 are multiplied by predetermined gains, and then converted into current instructions, which are fed back to the current instructions to the electric motor 41b and the electric motor 41c, respectively. When the position compensation amount Zp_JT2 and the position compensation amount Zp_JT3 are fed back to the current instructions to the electric motor 41b and the electric motor 41c, respectively, a low frequency component such as noise and offset is eliminated from the position compensation amount Zp_JT2 and the position compensation amount Zp_JT3.

### <Acquisition of Velocity Compensation for Second Driving Shaft>

Acquisition of the position compensation amount for the second driving axis unit 12b is described. Because the rotation axes of the second driving axis unit 12b and the third driving axis unit 12c are parallel to each other, and operating directions of the second driving axis unit 12b and the third driving axis unit 12c are the same, the velocity compensation for the second driving axis unit 12b is acquired based on interference of inertia of the second driving axis unit 12b and the third driving axis unit 12c.

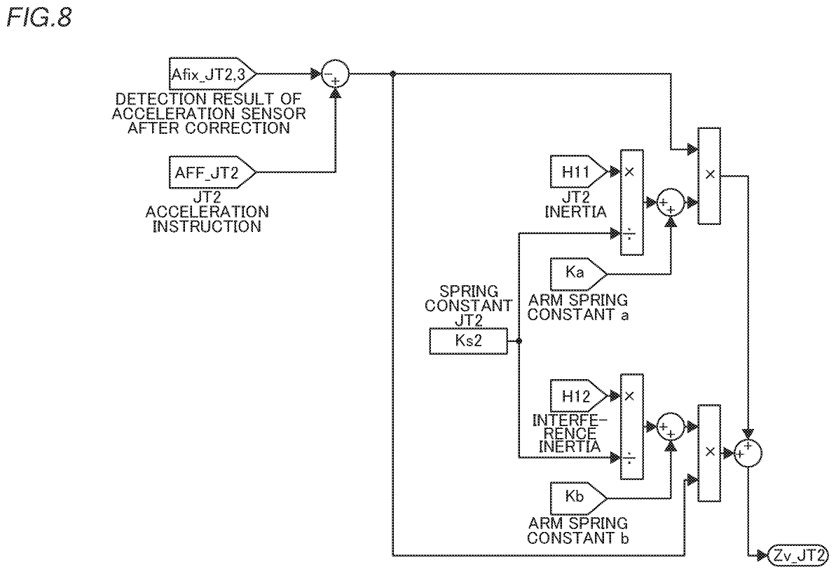

FIG. 8 is a diagram illustrating exemplary acquisition of a velocity compensation amount of the second driving axis unit 12b based on the above formula (9). As shown in FIG. 8, the detection result Afix_JT2,3 of the acceleration sensor 13b that is obtained by executing correction of an inclination of the acceleration sensor 13b relative to the to-be-compensated driving axis unit 12b and elimination of a gravitational acceleration component included in the detection result of the acceleration sensor 13b is acquired. Also, an acceleration instruction AFF_JT2 to the second driving axis unit 12b is acquired. Specifically, similar to correction of the inclination of the acceleration sensor 13b, the acceleration instruction AFF_JT2 to the second driving axis unit 12b is acquired by applying coordinate transformation of the not-to-be-compensated driving axis units 12d, 12e and 12f, which are driving axis units other than the to-be-compensated driving axis unit 12b, to the acceleration instruction to the distal end of the arm 11. Subsequently, (AFF_JT2−Afix_JT2,3) is acquired by subtracting the detection result Afix_JT2,3 from the acceleration instruction AFF_JT2.

Also, inertia H11 about the second driving axis unit 12b is acquired. Also, a spring constant Ks2 of the second driving axis unit 12b is acquired. Subsequently, H11/Ks2 is acquired by dividing the inertia H11 by the spring constant Ks2. (H11/Ks2+Ka) is acquired by adding H11/Ks2 and the arm spring constant Ka together. Subsequently, (H11/Ks2+Ka)×(AFF_JT2−Afix_JT2,3) is acquired by multiplying (H11/Ks2+Ka) by (AFF_JT2−Afix_JT2,3).

Also, the interference inertia H12 between the second driving axis unit 12b and the third driving axis unit 12c is acquired. Also, a spring constant Ks2 of the second driving axis unit 12b is acquired. Subsequently, H12/Ks2 is acquired by dividing the interference inertia H12 by the spring constant Ks2. (H12/Ks2+Kb) is acquired by adding H12/Ks2 and the arm spring constant Kb together. Subsequently, (H12/Ks2+Kb)×(AFF_JT2−Afix_JT2,3) is acquired by multiplying (H12/Ks2+Kb) by (AFF_JT2−Afix_JT2,3).

Subsequently, the velocity compensation Zv_JT2 for the second driving axis unit 12b is acquired by adding (H11/Ks2+Ka)×(AFF_JT2−Afix_JT2,3) and (H12/Ks2+Kb)×(H12/Ks2+Kb)×(AFF_JT2−Afix_JT2,3) together. The velocity compensation amount Zv_JT2 is multiplied by a predetermined gain, and then converted into a current instruction, which is fed back to the current instruction to the electric motor 41b. When the velocity compensation amount Zv_JT2 is fed back to the current instruction to the electric motor 41b, a low frequency component such as noise and offset is eliminated from the velocity compensation amount Zv_JT2 by a high pass filter.

### <Acquisition of Velocity Compensation for Third Driving Shaft>

Acquisition of the position compensation amount for the third driving axis unit 12c is described. Because the rotation axes of the second driving axis unit 12b and the third driving axis unit 12c are parallel to each other, and operating directions of the second driving axis unit 12b and the third driving axis unit 12c are the same, the velocity compensation for the third driving axis unit 12c is acquired based on interference of inertia of the second driving axis unit 12b and the third driving axis unit 12c.

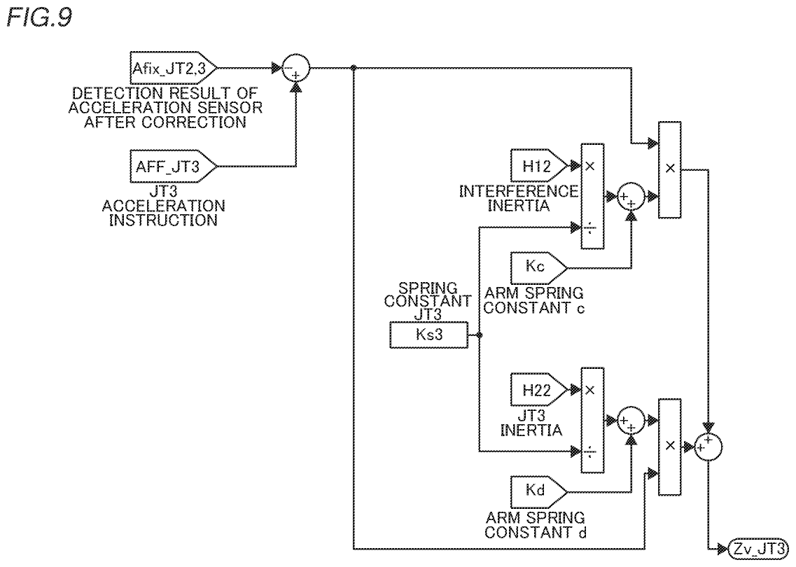

FIG. 9 is a diagram illustrating exemplary acquisition of a velocity compensation amount of the third driving axis unit 12c based on the above formula (9). As shown in FIG. 9, the detection result Afix_JT2,3 of the acceleration sensor 13b that is obtained by executing correction of an inclination of the acceleration sensor 13b relative to the to-be-compensated driving axis unit 12b and elimination of a gravitational acceleration component included in the detection result of the acceleration sensor 13b is acquired. Also, an acceleration instruction AFF_JT3 to the third driving axis unit 12c is acquired. Specifically, similar to correction of the inclination of the acceleration sensor 13b, the acceleration instruction AFF_JT3 to the third driving axis unit 12c is acquired by applying coordinate transformation of the not-to-be-compensated driving axis units 12d, 12e and 12f, which are driving axis units other than the to-be-compensated driving axis unit 12c, to the acceleration instruction to the distal end of the arm 11. Subsequently, (AFF_JT3−Afix_JT2,3) is acquired by subtracting the detection result Afix_JT2,3 from the acceleration instruction AFF_JT3.

Also, inertia H22 about the third driving axis unit 12c is acquired. Also, a spring constant Ks3 of the third driving axis unit 12c is acquired. Subsequently, H22/Ks3 is acquired by dividing the inertia H22 by the spring constant Ks3. (H22/Ks3+Kd) is acquired by adding H22/Ks3 and the arm spring constant Kd together. Subsequently, (H22/Ks3+Kd)×(AFF_JT3−Afix_JT2,3) is acquired by multiplying (H22/Ks3+Kd) by (AFF_JT3−Afix_JT2,3)

Also, the interference inertia H12 between the second driving axis unit 12b and the third driving axis unit 12c is acquired. Also, a spring constant Ks3 of the third driving axis unit 12b is acquired. Subsequently, H12/Ks3 is acquired by dividing the interference inertia H12 by the spring constant Ks3. (H12/Ks3+Kc) is acquired by adding H12/Ks3 and the arm spring constant Kc together. Subsequently, (H12/Ks3+Kc)×(AFF_JT3−Afix_JT2,3) is acquired by multiplying (H12/Ks3+Kc) by (AFF_JT3−Afix_JT2,3).

Subsequently, the position compensation Zv_JT3 for the third driving axis unit 12c is acquired by adding (H22/Ks3+Kd)×(AFF_JT3−Afix_JT2,3) and (H12/Ks3+Kc)×(AFF_JT3−Afix_JT2,3) together. The velocity compensation amount Zv_JT3 is multiplied by a predetermined gain, and then converted into a current instruction, which is fed back to the current instruction to the electric motor 41b. When the velocity compensation amount Zv_JT3 is fed back to the current instruction to the electric motor 41b, a low frequency component such as noise and offset is eliminated from the velocity compensation amount Zv_JT3 by a high pass filter.

### (Control Processing Relating to Acquisition of Position Compensation Amount)

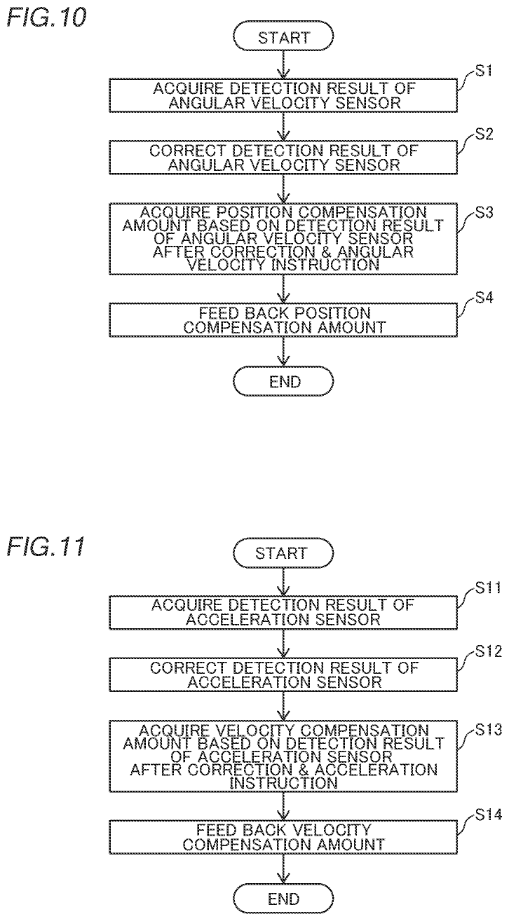

Control processing of acquisition of a position compensation amount by the robot 100 according to this embodiment is described with reference to a flowchart of FIG. 10. Processes in the flowchart is executed out by the controller 20.

As shown in FIG. 10, in step S1, a detection result of the angular velocity sensor 13a is acquired. Subsequently, in step S2, the detection result of the angular velocity sensor 13a is corrected. That is, an inclination of the angular velocity sensor 13a relative to the to-be-compensated driving axis unit is corrected. Also, angular velocity components of the not-to-be-compensated driving axis units, which are driving axis units other than the to-be-compensated driving axis unit, are corrected. In a case in which the to-be-compensated driving axis unit is the first driving axis unit 12a, angular velocity components of the second driving axis unit 12b and the third driving axis unit 12c do not affect the detection result of the angular velocity sensor, subtraction of the angular velocity components of the second driving axis unit and the third driving axis unit do not necessarily to be executed. Subsequently, in step S3, the position compensation amount is acquired based on the detection result of the angular velocity sensor 13a after correction and an angular velocity instruction to the to-be-compensated driving axis unit. Subsequently, in step S4, the position compensation amount is fed back to a current instruction to the electric motor of the to-be-compensated driving axis unit.

### (Control Processing Relating to Acquisition of Velocity Compensation Amount)

Control processing of acquisition of a velocity compensation amount by the robot 100 according to this embodiment is described with reference to a flowchart of FIG. 11. Processes in the flowchart is executed out by the controller 20.

As shown in FIG. 11, in step S11, a detection result of the acceleration sensor 13b is acquired. Subsequently, in step S12, the detection result of the acceleration sensor 13b is corrected. That is, an inclination of the acceleration sensor 13b relative to the to-be-compensated driving axis unit is corrected. Also, a gravitational acceleration component included in the detection result of the acceleration sensor 13b is eliminated. Subsequently, in step S13, the velocity compensation amount is acquired based on the detection result of the acceleration sensor 13b after correction and an acceleration instruction to the to-be-compensated driving axis unit. Subsequently, in step S14, the velocity compensation amount is fed back to a current instruction to the electric motor of the to-be-compensated driving axis unit.

### Advantages of the Embodiment

In this embodiment, as described above, the controller 20 is configured to correct a detection result of the inertia sensor 13 to compensate for vibration, and to acquire a compensation amount for the vibration based on the corrected detection result of the inertia sensor 13. As a result, a compensation amount can be accurately acquired based on the corrected detection result of the inertia sensor 13. Consequently, because accuracy of compensation can be improved, it is possible to accurately suppress vibration.

In this embodiment, as described above, the controller 20 is configured to acquire a compensation amount for vibration based on a detection result of the inertia sensor 13 acquired by executing at least one of correction of an inclination of the inertia sensor 13 relative to the to-be-compensated driving axis unit and elimination of a gravitational acceleration component included in a detection result that is detected by the inertia sensor 13 is provided. Accordingly, in a case in which an inclination of the inertia sensor 13 relative to the to-be-compensated driving axis unit is corrected, because the inclination of the inertia sensor 13 that changes in accordance with a posture of the robot body 10 can be corrected, it is possible to accurately acquire a compensation amount. Also, in a case in which a gravitational acceleration component included in the detection result of the inertia sensor 13 is eliminated, because the gravitational acceleration component, which is inevitably included in the detection result of the inertia sensor 13, can be eliminated, it is possible to accurately acquire the compensation amount. Consequently, because accuracy of compensation can be improved, it is possible to accurately suppress vibration.

In this embodiment, as described above, the controller 20 is configured to obtain the detection result of the inertia sensor 13 corrected based on an inclination of the not-to-be-compensated driving axis unit arranged between the inertia sensor 13 and the to-be-compensated driving axis unit. Accordingly, because an inclination of the inertia sensor 13 relative to the to-be-compensated driving axis unit can be easily and accurately corrected based on correspondence between the inclination of the inertia sensor 13 relative to the to-be-compensated driving axis unit and an inclination of the not-to-be-compensated driving axis unit arranged between the inertia sensor 13 and the to-be-compensated driving axis unit, it is possible to easily improve accuracy of compensation.

In this embodiment, as described above, the controller 20 is configured to apply coordinate transformation of not-to-be-compensated driving axis units, which are the driving axis units other than the to-be-compensated driving axis unit, to a detection result that is detected by the inertia sensor 13. Accordingly, because an inclination of the inertia sensor 13 relative to the to-be-compensated driving axis unit can be more easily and accurately corrected based on correction of the not-to-be-compensated driving axis unit that can be executed by applying the coordinate transformation, it is possible to more easily improve accuracy of compensation.

In this embodiment, as described above, the controller 20 is configured to acquire the gravitational acceleration component based on a rotation matrix based on coordinate transformation matrices of the plurality of driving axis units 12a, 12b, 12c, 12d, 12e and 12f, and to subtract the acquired gravitational acceleration component from the detection result that is detected by the inertia sensor 13. Accordingly, the gravitational acceleration component included in the detection result of the inertia sensor 13 can be easily and reliably eliminated, it possible to improve accuracy of compensation.

In this embodiment, as described above, the inertia sensor 13 includes the angular velocity sensor 13a and the acceleration sensor 13b; and the controller 20 is configured to acquire position compensation amounts based on the detection results of the angular velocity sensor 13a, and to acquire velocity compensation amounts based on a detection results of the acceleration sensor 13b. Accordingly, compensation can be executed in consideration of both position compensation and velocity compensation, it is possible to effectively improve accuracy of compensation as compared with a case in which compensation can be executed in consideration of only one of the position compensation and the velocity compensation.

In this embodiment, as described above, the controller 20 is configured to acquire the position compensation amount based on the detection results of the angular velocity sensor 13a that are subjected to correction of inclinations of the angular velocity sensor 13a relative to the to-be-compensated driving axis units and correction of angular velocity components of the not-to-be-compensated driving axis units arranged between the angular velocity sensor 13a and the to-be-compensated driving axis units, and angular velocity instructions to the to-be-compensated driving axis units. Accordingly, because the position compensation amount can be easily and accurately acquired, it is possible to easily improve accuracy of compensation based on the position compensation amount.

In this embodiment, as described above, the controller 20 is configured to acquire the velocity compensation amounts based on the detection results of the acceleration sensor 13b that are obtained by executing correction of inclinations of the acceleration sensor 13b relative to the to-be-compensated driving axis units and elimination of the gravitational acceleration component included in the detection result that is detected by the acceleration sensor 13b, and acceleration instructions to the to-be-compensated driving axis units. Accordingly, because the velocity compensation amount can be easily and accurately acquired, it is possible to easily improve accuracy of compensation based on the velocity compensation amount.

In this embodiment, as described above, the plurality of driving axis units 12a, 12b, 12c, 12d, 12e and 12f include a first driving axis unit 12a, a second driving axis unit 12b, and a third driving axis unit 12c arranged in this order from a proximal end side; and the controller 20 is configured to acquire compensation amounts of the three driving axis units, which are the first driving axis unit 12a, the second driving axis unit 12b and the third driving axis unit 12c. Accordingly, because compensation amounts of the first driving axis unit 12a, the second driving axis unit 12b and the third driving axis unit 12c on the proximal end side, which have a large effect of suppressing vibration, it is possible to effectively suppressing vibration.

In this embodiment, as described above, the rotation axis A2 of the second driving axis unit 12b and the rotation axis A3 of the third driving axis unit 12c are parallel to each other; and the controller 20 is configured to acquire the compensation amounts of the second driving axis unit 12b and the third driving axis unit 12c based on interference of inertia of the second driving axis unit 12b and the third driving axis unit 12c. Accordingly, because the rotation axes of the second driving axis unit 12b and the third driving axis unit 12c are parallel to each other, even in a case in which interference of inertia of the second driving axis unit 12b and the third driving axis unit 12c occurs, accuracy of compensation for the second driving axis unit 12b and the third driving axis unit 12c can be accurately compensated in consideration of the interference of inertia of the second driving axis unit 12b and the third driving axis unit 12c.

In this embodiment, the inertia sensor 13 is arranged on the distal end side of the arm 11 with respect to the to-be-compensated driving axis unit. Accordingly, because vibration can be detected by the inertia sensor 13 at a position closer to the distal end of the arm 11 in which the vibration causes a problem due to movement of the workpiece, it is possible to easily compensate for vibration based on the detection result of the inertia sensor 13.

In this embodiment, as described above, the inertia sensor 13 is arranged in the distal end part of the arm 11. Accordingly, because vibration can be detected by the inertia sensor 13 at a position still closer to the distal end of the arm 11, it is possible to more easily compensate for vibration based on the detection result of the inertia sensor 13.

In this embodiment, as described above, the robot body 10 is a 6-axis vertical multi-joint type. Accordingly, it is possible to improve accuracy of compensation so as to accurately suppress vibration in the 6-axis vertical multi-joint robot body 10.

### Modified Embodiments

Note that the embodiment disclosed this time must be considered as illustrative in all points and not restrictive. The scope of the present disclosure is not shown by the above description of the embodiments but by the scope of claims for patent, and all modifications (modified embodiments) within the meaning and scope equivalent to the scope of claims for patent are further included.

While the example in which both correction of an inclination of the inertia sensor relative to the to-be-compensated driving axis unit, and elimination of a gravitational acceleration component included in a detection result that is detected by the inertia sensor are executed has been shown in the aforementioned embodiment, the present disclosure is not limited to this. In the present disclosure, alternatively, only one of correction of an inclination of the inertia sensor relative to the to-be-compensated driving axis unit, and elimination of a gravitational acceleration component included in a detection result that is detected by the inertia sensor can be executed. Also, the detection result of the inertia sensor can be obtained by executing correction of a compensation amount for vibration other than correction of an inclination of the inertia sensor relative to the to-be-compensated driving axis unit, and elimination of a gravitational acceleration component included in a detection result that is detected by the inertia sensor.

While the example in which the inertia sensors include the angular velocity sensor and the acceleration sensor has been shown in the aforementioned embodiment, the present disclosure is not limited to this. In the present disclosure, alternatively, the inertia sensor can include only the angular velocity sensor or the acceleration sensor.

While the example in which the inertia sensor is arranged in a distal end part of the arm has been shown in the aforementioned embodiment, the present disclosure is not limited to this. In the present disclosure, alternatively, the inertia sensor can be arranged in a part other than the distal end part of the arm.

While the example in which compensation amounts of the first driving axis unit, the second driving axis unit and the third driving axis unit are acquired has been shown in the aforementioned embodiment, the present disclosure is not limited to this. In the present disclosure, alternatively, the compensation amount(s) of any one or two of to the first driving axis unit, the second driving axis unit and the third driving axis unit can be acquired. Also, a compensation amount of the driving axis unit other than the first driving axis unit, the second driving axis unit and the third driving axis unit can be acquired.

While the example in which the robot body is a 6-axis vertical multi-joint type has been shown in the aforementioned embodiment, the present disclosure is not limited to this. In the present invention, alternatively, the robot can be a type other than the 6-axis vertical multi-joint type.

Functions of elements disclosed in this specification can be realized by a circuit or processing circuit including a general purpose processor, a dedicated processor, an integrated circuit, ASIC (Application Specific Integrated Circuits), a conventional circuit and/or combination of them configured or programmed to realize the functions disclosed. Because processors include transistors and other circuits, they are considered as a processing circuit or a circuit. In the present disclosure, circuits, units or means are hardware for realizing the functions stated above, or hardware programmed to realize the functions stated above. The hardware can be hardware disclosed in this specification, or can be other known hardware programed or configured to realize the functions stated above. In the case in which the hardware is a processor that can be considered as one type of circuits, the circuit, means or unit is a combination of hardware and software, and the software is used for configuration of the hardware and/or the processor.

### [Modes]

The aforementioned exemplary embodiment will be understood as concrete examples of the following modes by those skilled in the art.

### (Mode Item 1)

A robot according to mode item 1 includes a robot body including an arm including a plurality of links, a plurality of driving axis units configured to drive the plurality of links, and an inertia sensor(s) included in the arm; and a controller configured to acquire a compensation amount(s) for vibration based on a detection result(s) of the inertia sensor(s) acquired by executing at least one of correction of an inclination(s) of the inertia sensor(s) relative to a to-be-compensated driving axis unit(s), which is/are the driving axis unit(s) that is/are to be subjected to compensation, and elimination of a gravitational acceleration component(s) included in a detection result(s) that is/are detected by the inertia sensor(s).

### (Mode Item 2)

In the robot according to mode item 1, the controller is configured to obtain the detection result(s) of the inertia sensor(s) corrected based on an inclination(s) of a not-to-be-compensated driving axis unit(s), which is/are the driving axis unit(s) other than the to-be-compensated driving axis unit(s), arranged between the inertia sensor(s) and the to-be-compensated driving axis unit(s).

### (Mode Item 3)

In the robot according to mode item 2, the controller is configured to apply coordinate transformation of the not-to-be-compensated driving axis unit(s) to a detection result(s) that is/are detected by the inertia sensor(s).

### (Mode Item 4)

In the robot according to any of mode items 1 to 3, the controller is configured to acquire the gravitational acceleration component based on a rotation matrix based on coordinate transformation matrices of the plurality of driving axis units, and to subtract the acquired gravitational acceleration component from the detection result that is detected by the inertia sensor.

### (Mode Item 5)

In the robot according to any of mode items 1 to 4, the inertia sensors include an angular velocity sensor and an acceleration sensor; and the controller is configured to acquire a position compensation amount(s) based on a detection result(s) of the angular velocity sensor, and to acquire a velocity compensation amount(s) based on a detection result(s) of the acceleration sensor.

### (Mode Item 6)

In the robot according to mode item 5, the controller is configured to acquire the position compensation amount(s) based on the detection result(s) of the angular velocity, which is/are acquired by executing the correction of the inclination(s) of the angular velocity sensor relative to the to-be-compensated driving axis unit(s) and correction of an angular velocity component(s) of a not-to-be-compensated driving axis unit(s), which is/are the driving axis unit(s) other than the to-be-compensated driving axis unit(s), arranged between the angular velocity sensor and the to-be-compensated driving axis unit(s), and an angular velocity instruction(s) to the to-be-compensated driving axis unit(s).

### (Mode Item 7)

In the robot according to mode item 5 or 6, the controller is configured to acquire the velocity compensation amount(s) based on the detection result(s) of the acceleration sensor, which is/are acquired by executing the correction of the inclination(s) of the acceleration sensor relative to the to-be-compensated driving axis unit(s) and elimination of the gravitational acceleration component included in the detection result that is detected by the acceleration sensor, and an acceleration instruction(s) to the to-be-compensated driving axis unit.

### (Mode Item 8)

In the robot according to any of mode items 1 to 7, the plurality of driving axis units include a first driving axis unit, a second driving axis unit, and a third driving axis unit arranged in this order from a proximal end side; and the controller is configured to acquire the compensation amounts of the three driving axis units, which are the first driving axis unit, the second driving axis unit and the third driving axis unit.

### (Mode Item 9)

In the robot according to mode item 8, a rotation axis of the second driving axis unit and a rotation axis of the third driving axis unit are parallel to each other; and the controller is configured to acquire the compensation amounts of the second driving axis unit and the third driving axis unit based on interference of inertia of the second driving axis unit and the third driving axis unit.

### (Mode Item 10)

In the robot according to any of mode items 1 to 9, the inertia sensor(s) is/are arranged on a distal end side of the arm with respect to the to-be-compensated driving axis unit(s).

### (Mode Item 11)

In the robot according to mode item 10, the inertia sensor(s) is/are arranged in a distal end part of the arm.

### (Mode Item 12)

In the robot according to any of mode items 1 to 11, the robot body is a 6-axis vertical multi-joint type.

### (Mode Item 13)

A robot according to mode item 13 includes a robot body including an arm including a plurality of links, a plurality of driving axis units configured to drive the plurality of links, and an inertia sensor(s) included in the arm; and a controller configured to correct a detection result(s) that is/are detected by the inertia sensor(s) to compensate for vibration, and to acquire a compensation amount(s) for the vibration based on the corrected detection result(s) of the inertia sensor(s).

What is claimed is:

1. A robot comprising:
a robot body including an arm including a plurality of links, a plurality of driving axis units configured to drive the plurality of links, and an inertia sensor(s) included in the arm; and
a controller configured to acquire a compensation amount(s) for vibration based on a detection result(s) of the inertia sensor(s) acquired by executing at least one of correction of an inclination(s) of the inertia sensor(s) relative to a to-be-compensated driving axis unit(s), which is/are the driving axis unit(s) that is/are to be subjected to compensation, and elimination of a gravitational acceleration component(s) included in a detection result(s) that is/are detected by the inertia sensor(s).

2. The robot according to claim 1, wherein the controller is configured to obtain the detection result(s) of the inertia sensor(s) corrected based on an inclination(s) of a not-to-be-compensated driving axis unit(s), which is/are the driving axis unit(s) other than the to-be-compensated driving axis unit(s), arranged between the inertia sensor(s) and the to-be-compensated driving axis unit(s).

3. The robot according to claim 2, wherein the controller is configured to apply coordinate transformation of the not-to-be-compensated driving axis unit(s) to a detection result(s) that is/are detected by the inertia sensor(s).

4. The robot according to claim 1, wherein the controller is configured to acquire the gravitational acceleration component based on a rotation matrix based on coordinate transformation matrices of the plurality of driving axis units, and to subtract the acquired gravitational acceleration component from the detection result that is detected by the inertia sensor.

5. The robot according to claim 1, wherein
the inertia sensors include an angular velocity sensor and an acceleration sensor; and
the controller is configured to acquire a position compensation amount(s) based on a detection result(s) of the angular velocity sensor, and to acquire a velocity compensation amount(s) based on a detection result(s) of the acceleration sensor.

6. The robot according to claim 5, wherein the controller is configured to acquire the position compensation amount(s) based on the detection result(s) of the angular velocity sensor, which is/are acquired by executing the correction of the inclination(s) of the angular velocity sensor relative to the to-be-compensated driving axis unit(s) and correction of an angular velocity component(s) of a not-to-be-compensated driving axis unit(s), which is/are the driving axis unit(s) other than the to-be-compensated driving axis unit(s), arranged between the angular velocity sensor and the to-be-compensated driving axis unit(s), and an angular velocity instruction(s) to the to-be-compensated driving axis unit(s).

7. The robot according to claim 5, wherein the controller is configured to acquire the velocity compensation amount(s) based on the detection result(s) of the acceleration sensor, which is/are acquired by executing the correction of the inclination(s) of the acceleration sensor relative to the to-be-compensated driving axis unit(s) and elimination of the gravitational acceleration component included in the detection result that is detected by the acceleration sensor, and an acceleration instruction(s) to the to-be-compensated driving axis unit(s).

8. The robot according to claim 1, wherein
the plurality of driving axis units include a first driving axis unit, a second driving axis unit, and a third driving axis unit arranged in this order from a proximal end side; and
the controller is configured to acquire the compensation amounts of the three driving axis units, which are the first driving axis unit, the second driving axis unit and the third driving axis unit.

9. The robot according to claim 8, wherein
a rotation axis of the second driving axis unit and a rotation axis of the third driving axis unit are parallel to each other; and
the controller is configured to acquire the compensation amounts of the second driving axis unit and the third driving axis unit based on interference of inertia of the second driving axis unit and the third driving axis unit.

10. The robot according to claim 1, wherein the inertia sensor(s) is/are arranged on a distal end side of the arm with respect to the to-be-compensated driving axis unit(s).

11. The robot according to claim 10, wherein the inertia sensor(s) is/are arranged in a distal end part of the arm.

12. The robot according to claim 1, wherein the robot body is a 6-axis vertical multi-joint type.

13. A robot comprising:
a robot body including an arm including a plurality of links, a plurality of driving axis units configured to drive the plurality of links, and an inertia sensor(s) included in the arm; and
a controller configured to correct a detection result(s) that is/are detected by the inertia sensor(s) to compensate for vibration, and to acquire a compensation amount(s) for the vibration based on the corrected detection result(s) of the inertia sensor(s).
